(19) United States
(12) Patent Application Publication
(10) Pub. No.: US 2007/0052281 A1
(43) Pub. Date: Mar. 8, 2007

(54) Apparatus mountable to an axle hub of a vehicle

(76) Inventor: Robert W. Stuckel, Arlington Heights, IL (US)

Correspondence Address: Douglas H. Pauley;Pauley Petersen & Erickson, Suite 365, 2800 West Higgins Road, Hoffman Estates, IL, 60195, US

(21) Appl. No.: 11/515,688

(22) Filed: Sep. 5, 2006

Related U.S. Application Data
(60) Provisional application No. 60/713,911, filed on Sep. 2, 2005.

(51) Int. Cl. B60B 7/04

(52) U.S. Cl. 301/37.26

(57) ABSTRACT

An apparatus mountable with respect to an axle hub of a vehicle including at least one plate detachably mountable with respect to the axle hub. Each plate forms a plurality of openings each positionable about a lug bolt fixed on the axle hub with respect to an axle of the vehicle. Each plate can further includes or forms a plurality of mounting holes. A cover forms an inner cavity, and at least one mounting bracket or connector is positioned at least partially within the inner cavity. Each mounting bracket can form a threaded hole alignable with a corresponding mounting hole. With the threaded hole of each mounting bracket aligned with a corresponding mounting hole formed in the plate, a fastening member extends through the mounting hole and is threadedly engageable with the corresponding threaded hole.

### BACKGROUND OF THE INVENTION

1. Field of the Invention

This invention relates to an apparatus mountable with respect to an axle hub of a vehicle and, particularly, to an apparatus including a cover mountable with respect to the axle hub.

2. Description of Related Art

Vehicles, and particularly large trucks, include rear wheels having a generally cylindrical rim around which a tire is mounted. The wheel rim includes a plurality of holes each alignable with a corresponding lug bolt extending from an axle hub and fixed with respect to an axle of the vehicle. The wheel rim is secured or fastened to the axle hub using a plurality of lug nuts each threadedly engageable with a corresponding lug bolt.

A hub cap or cover can be mounted over a portion of the axle hub that extends outwardly from the wheel rim. The cover is positionable over the axle hub portion to protect the axle hub from environmental conditions and/or to provide enhanced aesthetics. Many conventional covers are secured to the axle hub using fasteners that extend through the front or outer surface of the cover and, thus, are exposed to the environmental conditions. Exposure to environmental conditions, such as rain, snow and salt, results in rusting and/or corrosion to the cover components and/or the fasteners, which makes the frequent removal of the cover required in the trucking industry increasing difficult.

Thus, there is a need for a cover that is easily mountable with respect to an axle hub of a vehicle.

### SUMMARY OF THE INVENTION

It is one object of this invention to provide a cover that is easily mountable with respect to an axle hub of a vehicle, and easily removable, as desired.

It is another object of this invention to provide a cover that can accommodate a center piece that is fixably or moveably mounted with respect to the cover.

It is another object of this invention to overcome one or more of the problems described above and/or associated with conventional axle hub caps or covers.

The above and other objects of this invention can be attained through an apparatus that is mountable with respect to an axle hub of a vehicle. The apparatus includes at least one plate, and in other embodiments a plurality of plates, such as two plates, each mounted with respect to the axle hub. Each plate forms a plurality of first holes or openings each positionable about a lug bolt fixed on the axle hub. A lug nut is threadedly engageable with a corresponding lug bolt to fasten and secure the plate to the axle hub. The plate may or may not further form a plurality of mounting holes. With the plate mounted to the axle hub, each mounting hole formed on the plate can be positioned radially outwardly from a periphery of the axle hub.

Each plate can have any suitable or desirable size, shape and/or configuration. Preferably, but not necessarily, when more than one plate is used to attach the apparatus to the axle hub, the plates have the same or similar size and shape. The plates are preferably fabricated or manufactured using a suitable stamping process, wherein the plates are stamped from a metal or other suitable material sheet. Each plate can have a desired size, shape and/or configuration to minimize the amount of scrap metal and/or wasted material produced during the stamping process. Other suitable fabricating or manufacturing methods or processes and/or other suitable materials having sufficient strength can be used to fabricate or manufacture the plates.

In certain embodiments of this invention, the apparatus also includes a cover that forms an inner cavity. The cover may have any suitable or desirable dimensions, shape and/or configuration. For example, the cover may have an outer periphery having a circular, elliptical, triangular, rectangular or polygonal shape. Preferably but not necessarily, at least an outer surface of the cover is plated with a polished plating surface layer. In one embodiment of this invention, a display piece or a housing is mounted with respect to the cover, such as affixed to the outer surface of the cover. The display piece or housing preferably has a weighted bottom portion to prevent rotation of the display piece with the cover as the cover rotates. Additionally, or alternatively, the outer surface of the cover may include an odometer and/or an embossed design, such as a repetitive embossed design.

In one embodiment of this invention, at least one mounting bracket, or a plurality of mounting brackets each is connected to form or at least partially cover the inner cavity. Preferably but not necessarily, each mounting bracket can be connected within the inner cavity using a projection weld or other suitable connecting or attaching method. Alternatively, in other embodiments of this invention, each mounting bracket may be integrated with the cover. The mounting bracket forms a threaded hole that is alignable with a corresponding mounting hole formed in the plate. A fastening member, such as a screw or a bolt, passes or extends from behind or in front of the plate, through the mounting hole aligned with the threaded hole. The fastening member threadedly engages within the threaded hole to secure the cover with respect to the axle hub, preferably but not necessarily in a detachable fashion.

In one embodiment of this invention, the apparatus includes a cover that includes a sidewall. The sidewall can have at least one mounting area formed in a portion of the sidewall and/or a face of the cover can have at least one mounting formed in a portion of the face. For example, adjacent sidewall portions and/or a face portion can each form a mounting area, for example at a bend or transition line or other suitable area. Preferably, opposing mounting areas are formed in corresponding sidewall portions or in at two or more positions at the face of the cover. A mounting bracket can include a first portion that is at least partially positionable within the mounting area and connectable or attachable to the cover. A second portion of the mounting bracket is positionable about at least a portion of a lug bolt fixed on the axle hub with respect to the axle. The second portion of the mounting bracket may form any suitable connector, such as a circular hole and a semi-circular or other non-circular opening, or any suitable attachment or connection portion.

In one embodiment of this invention, the cover forms at least one flared flange extending outwardly from a sidewall of the cover. For example, each sidewall portion forming the sidewall may include or form a flared flange covering a portion of the axle hub extending radially outwardly from the cover. In another embodiment of this invention, the face of the cover can form any suitable opening to accommodate a fastener, such as a countersink and/or a screw.

Other objects and advantages of this invention are apparent to those skilled in the art, in view of the following detailed description taken in conjunction with the appended claims and drawings.

### BRIEF DESCRIPTION OF THE DRAWINGS

FIG. 1 is a front view of plates, according to one embodiment of this invention;

FIG. 2 is a front view of two plates mounted and secured with lug nuts to an axle hub of a vehicle, according to one embodiment of this invention;

FIG. 3 is a rear view of two plates positioned within an inner cavity formed in a cover of the apparatus and supported by a plurality of mounting brackets connected to the cover, according to one embodiment of this invention;

FIG. 4 is a top view of a cover, according to one embodiment of this invention;

FIG. 5 is a bottom view of the cover shown in FIG. 4, including a plurality of mounting brackets connected to the cover;

FIG. 6 is a top view of a mounting bracket, according to one embodiment of this invention;

FIG. 7 is a side view of the mounting bracket shown in FIG. 6;

FIG. 8 is a top view of a cover including opposing mounting areas formed in a portion of a sidewall of the cover, according to one embodiment of this invention;

FIG. 9 is a perspective side view of a cover including a mounting area formed in a portion of a sidewall of the cover, according to one embodiment of this invention;

FIG. 10 is a front view of a mounting bracket, according to one embodiment of this invention;

FIG. 11 is a front view of a mounting bracket, according to another embodiment of this invention;

FIG. 12 is a partial sectional view taken along a center line of a cover mounted with respect to an axle hub, with an emblem mounted with respect to the cover, according to one embodiment of this invention;

FIG. 13 is a bottom view of the cover and a corresponding plate, according to the embodiment shown in FIG. 12;

FIG. 14 is a partial sectional view taken along a centerline of a cover mounted with respect to an axle hub, with a housing mounted with respect to the cover, according to another embodiment of this invention; and

FIG. 15 is a bottom view of the cover and a corresponding plate, as shown in FIG. 14.

### DETAILED DESCRIPTION OF THE INVENTION

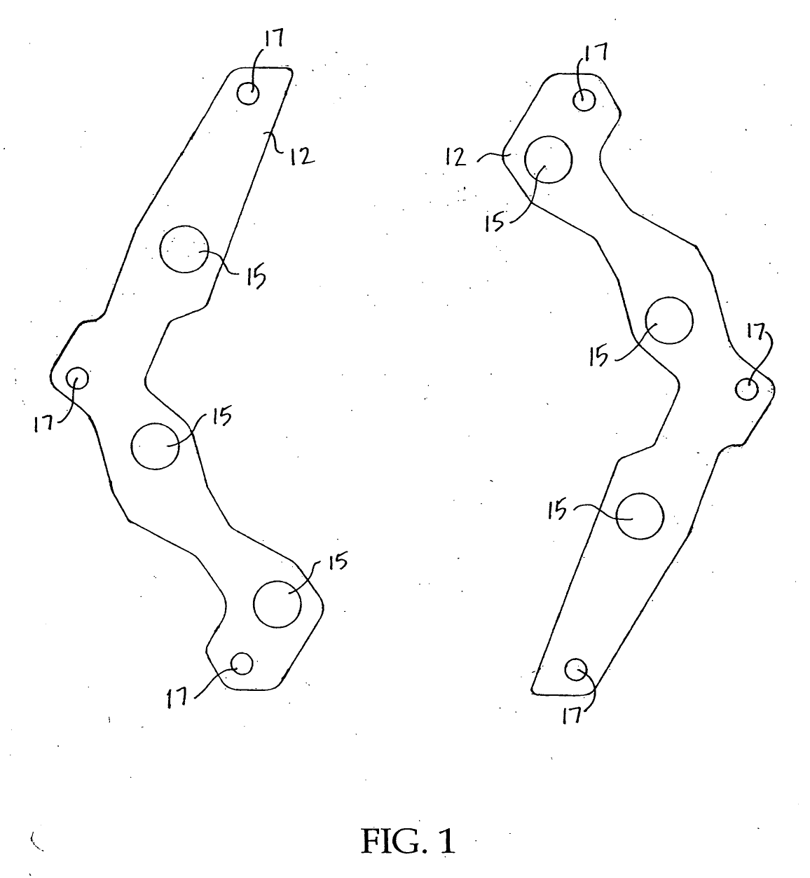

Referring to FIGS. 1-15, the present invention provides an apparatus 10 that is mountable to an axle hub 100, such as of a vehicle.

In one embodiment of this invention, apparatus 10 includes at least one plate 12 mountable with respect to axle hub 100. As shown in FIGS. 1-3, apparatus 10 preferably, but not necessarily, includes two plates 12 having the same or similar size and shape. Each plate 12 is mountable with respect to axle hub 100. In some embodiments of this invention, each plate 12 is detachably mounted for easy attachment and detachment, with respect to axle hub 100. Plate 12 can have any suitable or desirable size, shape and/or configuration. Plate 12 is preferably made of a suitable metal or other rigid material. Other suitable materials having sufficient strength can be used to fabricate or manufacture plate 12. In one embodiment of this invention, plates 12 are formed using a stamping process. Each plate 12 has a desired shape, such as shown in FIGS. 1-3, 13 and 15, to minimize the amount of scrap metal and/or wasted material produced during the stamping process. Other suitable fabricating or manufacturing methods or processes known to those skilled in the art may be used to make plates 12.

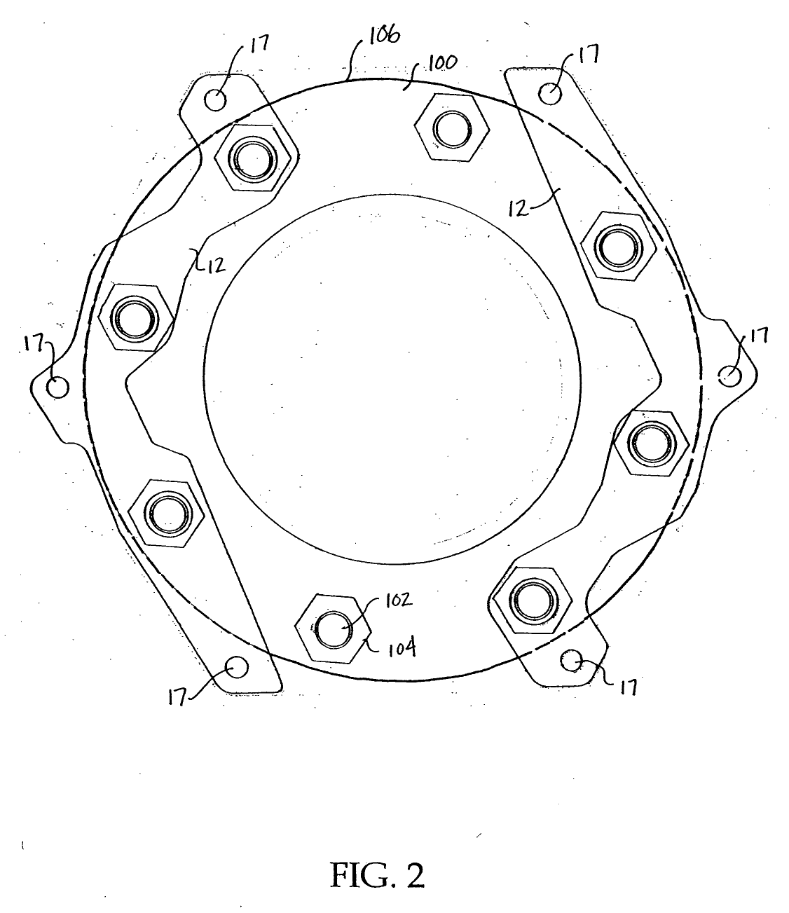

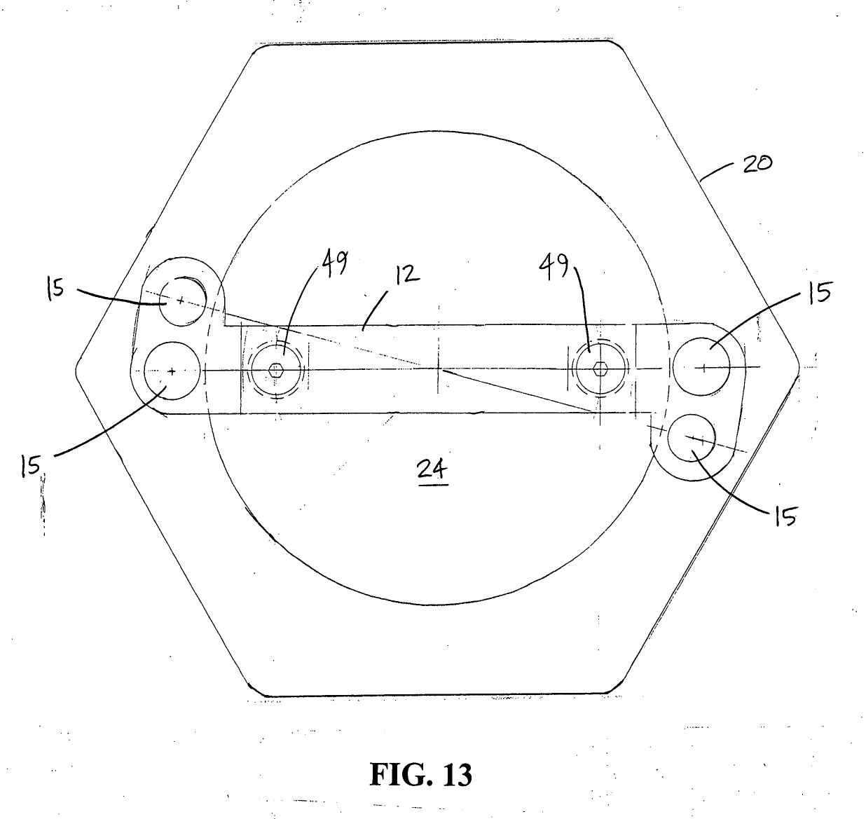

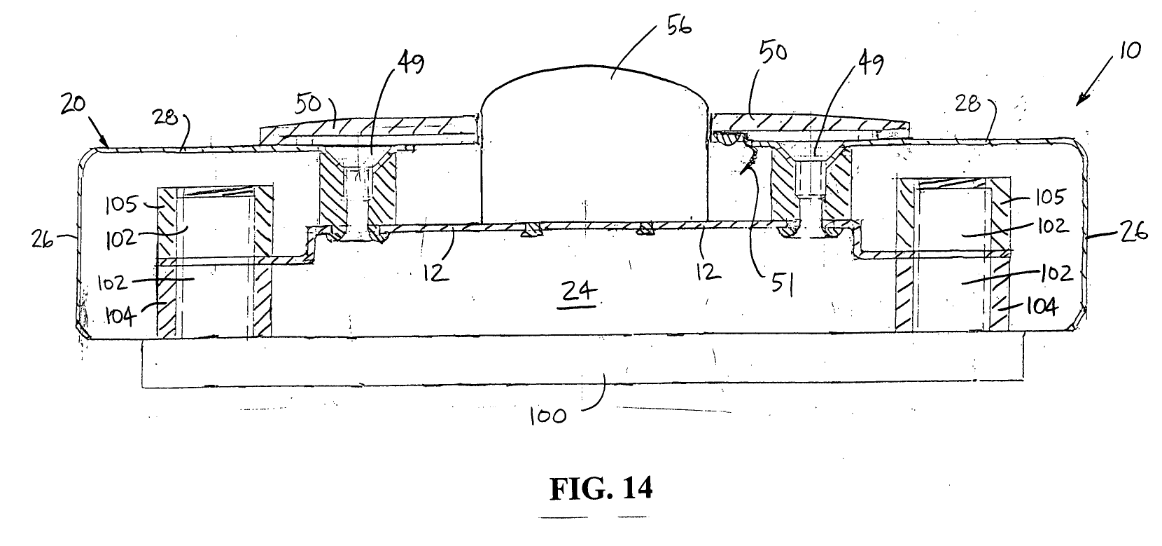

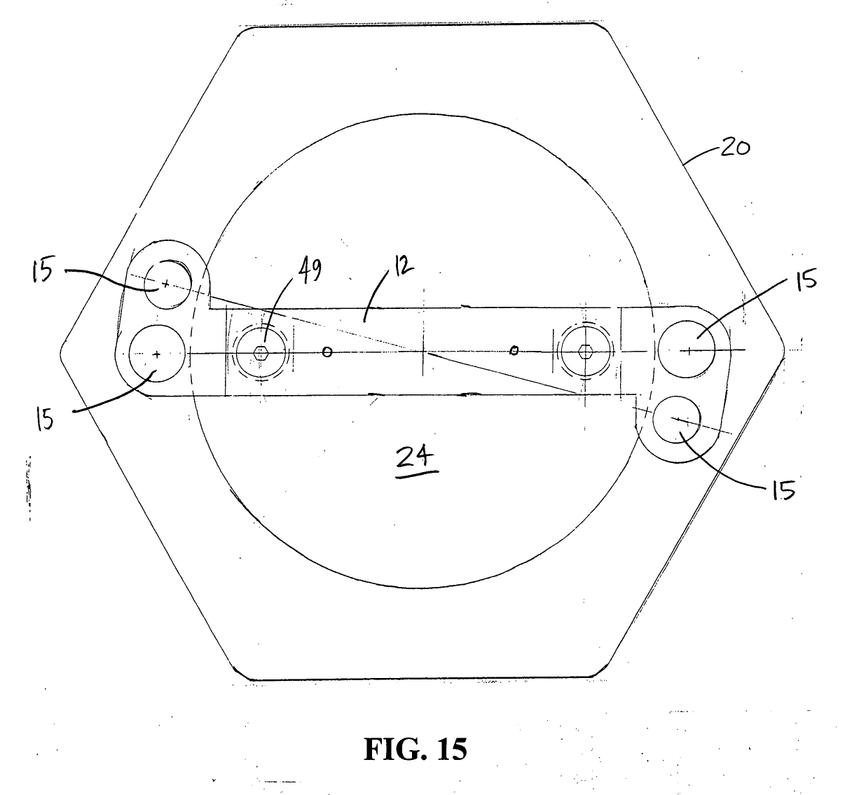

In certain embodiments of this invention, each plate 12 includes or forms a plurality of holes or openings 15 having a suitable size and/or shape to be positionable about a lug bolt 102 fixed on axle hub 100. Preferably but not necessarily, opening 15 is generally circular. As shown in FIG. 2, each plate 12 forms three openings 15 each positionable about a lug bolt 102 of axle hub 100. FIGS. 13 and 15 show another embodiment of this invention, where each plate 12 forms opening 15. As shown in FIGS. 13 and 15, each end portion of plate 12 has two openings 15, each of a different diameter or size, for example to accommodate differently sized lug bolts 102. As shown in FIGS. 13 and 15, plate 12 can be rotated about a centerline axis to aline a differently sized opening 15. Each plate 12 is mounted to axle hub 100 and secured thereto using a suitable lug nut 104 threadedly engageable with or attachable to lug bolt 102.

As shown in FIGS. 1-3, each plate 12 further includes or forms a plurality of suitably sized mounting opening or holes 17, preferably but not necessarily smaller than holes 15. Mounting holes 17 are preferably generally circular and allow a fastening member, such as a screw or a bolt, to pass therethrough for engagement with a threaded hole formed in a mounting bracket, as discussed below. As shown in FIGS. 1-3 for example, each connecting member 12 forms three mounting holes 17 suitably positioned on plate 12 at a determined distance from adjacent mounting holes 17. Referring further to FIG. 2, with plate 12 fastened or secured to axle hub 100, each mounting hole 17 is positioned or extends radially outwardly from or beyond a periphery 106 of axle hub 100.

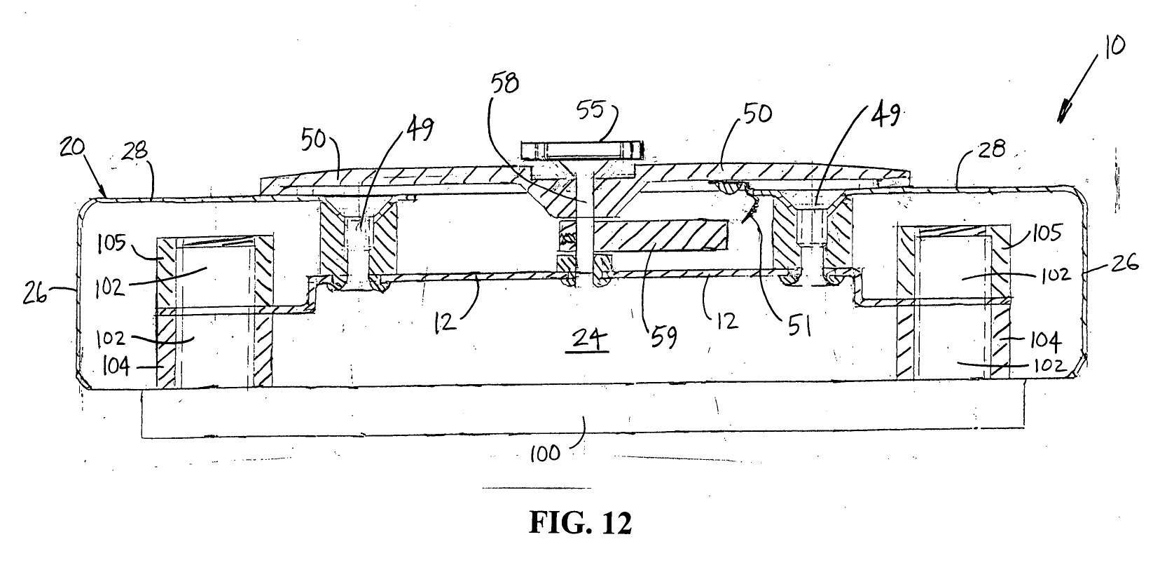

FIGS. 12-15 show other embodiments of plate 12 having holes 17 formed by countersinks or any other suitable structure that can accommodate a screw or another fastener used to connect cover 20 with respect to plate 12.

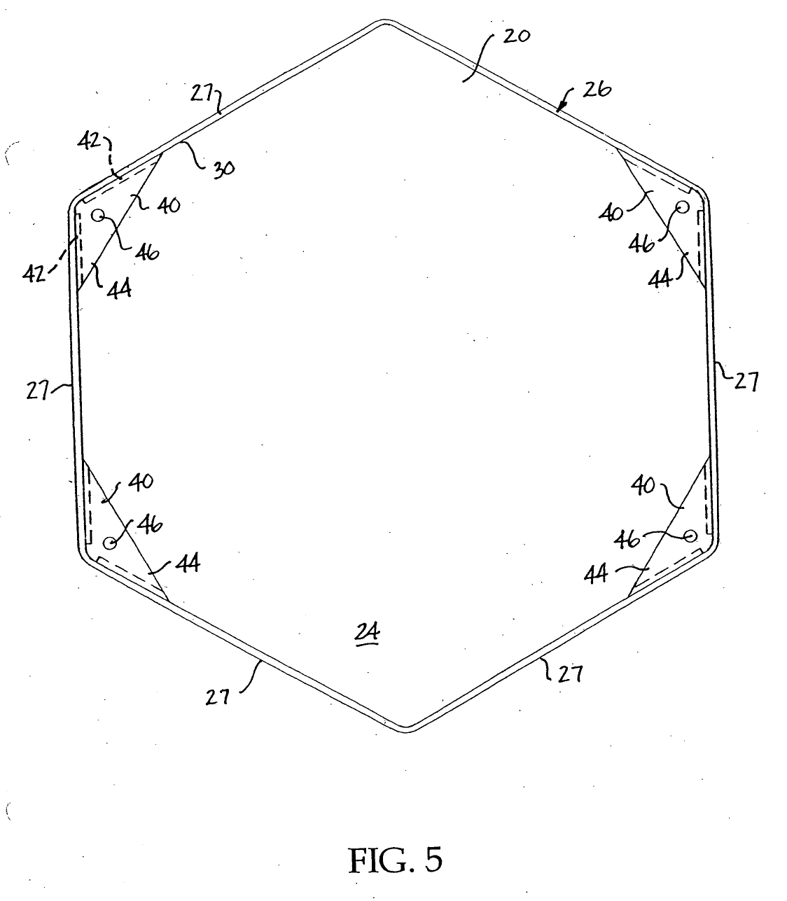

Apparatus 10 also includes a cover 20, as shown in FIGS. 2-5 and 12-15. Cover 20 may have any suitable size, shape and/or configuration. For example, cover 20 may have an outer periphery 22 having a circular, elliptical, triangular, rectangular or polygonal shape, as well as any other suitable or desirable shape. In one embodiment of this invention, cover 20 forms or defines an inner cavity 24 suitable for positioning cover 20 with respect to axle hub 100. Preferably, but not necessarily, inner cavity 24 has a sufficient depth to substantially cover axle hub 100. In one embodiment of this invention, cover 20 includes a sidewall 26 that transitions into a face or top wall 28 to form inner cavity 24. Sidewall 26 can include one continuous sidewall or may include a plurality of sidewall portions or segments 27, which are connected, bent and/or formed to form sidewall 26, as shown in FIG. 5.

Cover 20 is preferably formed or made of a suitable metal or other rigid material. Other suitable materials having sufficient strength, such as suitable alloy, composite, graphite and/or plastic materials may be used to form cover 20. Further, cover 20 may be fabricated or manufactured using any suitable process known to those having ordinary skill in the art. Preferably but not necessarily, cover 20 includes a polished copper, nickel or chrome plating material layer, for example. Any suitable plating process known to those having ordinary skill in the art can be used to apply the plating material layer to at least a portion of cover 20, such as an outer surface 32 of cover 20.

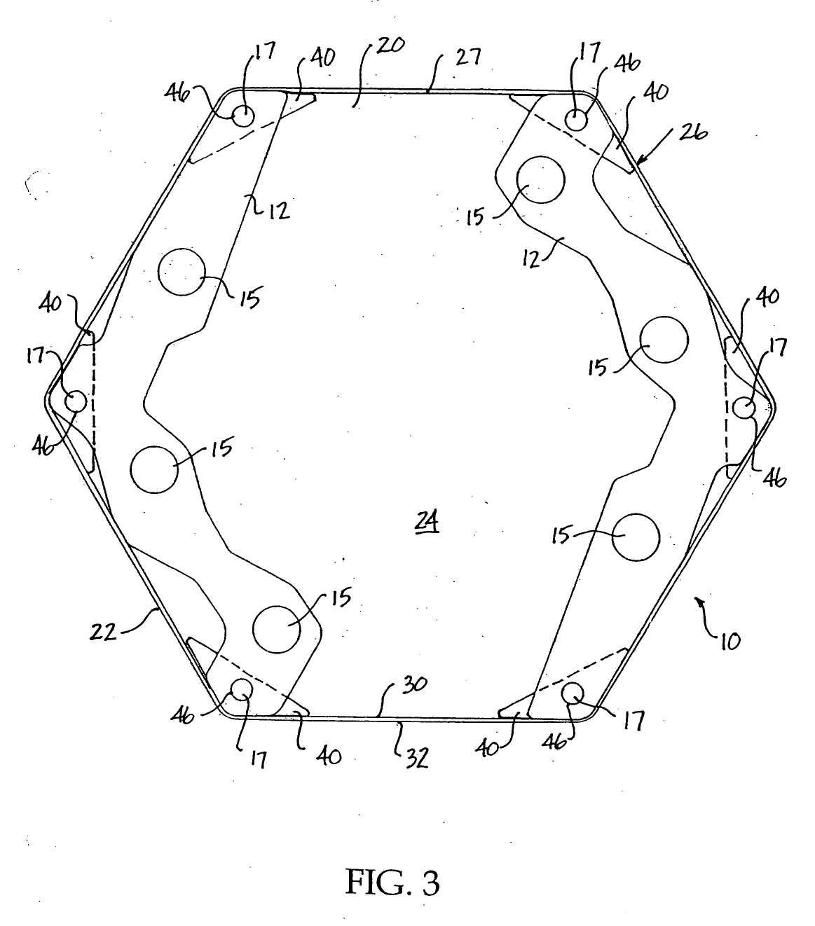

As shown in FIGS. 3 and 5, at least one mounting bracket 40 is connected with respect to and/or mounted within inner cavity 24. Preferably, a plurality of mounting brackets 40 are positioned about and connected or secured to an inner surface 30 of sidewall 26. For example, apparatus 10 may include four mounting brackets 40 positioned about and connected to inner surface 30, as shown in FIG. 5, or apparatus 10 may include six mounting brackets positioned about and connected to inner surface 30, as shown in FIG. 3. It is apparent to those skilled in the art that apparatus 10 may include any suitable number of mounting brackets 40. Having a plurality of mounting brackets 40 increases the support provided to plates 12 positioned within inner cavity 24 and contacting mounting brackets 40, as shown in FIG. 3. Preferably but not necessarily, each mounting bracket 40 is secured to inner surface 30 using a projection welding process, wherein a bead formed on each mounting bracket 40 is heated to melt and secure mounting bracket 40 to inner surface 30. Other suitable welding or other methods or processes known to those having ordinary skill in the art may be used to secure mounting bracket 40 to cover 20. Alternatively, mounting bracket 40 may be integrated with cover 20.

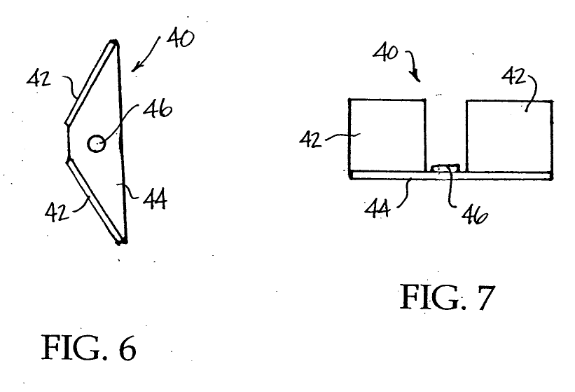

Referring to FIGS. 6 and 7, mounting bracket 40 preferably includes at least one leg 42 that contacts or interferes with inner surface 30 of cover 20 to support mounting bracket 40 with respect to inner cavity 24. As shown in FIGS. 6 and 7, in preferred embodiments of this invention, mounting bracket 40 includes two legs 42 extending from a platform 44. Platform 44 includes or forms a threaded hole 46 through platform 44. Referring to FIG. 3, threaded hole 46 is alignable with a mounting hole 17 formed in plate 12. For example, with plates 12 secured with respect to axle hub 100, as shown in FIG. 2, cover 20 is positionable over plates 12 so that each threaded hole 46 is aligned with a corresponding or cooperating mounting hole 17 formed in one of plates 12. With plates 12 preferably fastened or secured with respect to axle hub 100, a fastening member (not shown), such as a suitably sized and threaded screw or bolt can extend or pass through mounting hole 17 and is threadedly engageable within the corresponding threaded hole 46 of mounting bracket 40.

In other embodiments according to this invention, such as shown in FIGS. 12-15, connector 49 is formed within or can be attached with respect to cover 20. As shown in FIGS. 12 and 14, connector 49 can comprise a screw mounted with an opening, such as a countersink, to detachably mount cover 40 with respect to plate 12. Any other suitable connector or fastener can be used to mechanically and/or magnetically fix cover 20 with respect to plate 12. As shown in FIGS. 12 and 14, lug nut 105 can be used with lug bolt 102, to fix the position of plate 12 with respect to axle hub 100. Any other suitable mechanical, magnetic and/or adhesive connection can be used to fix plate 12 with respect to axle hub 100.

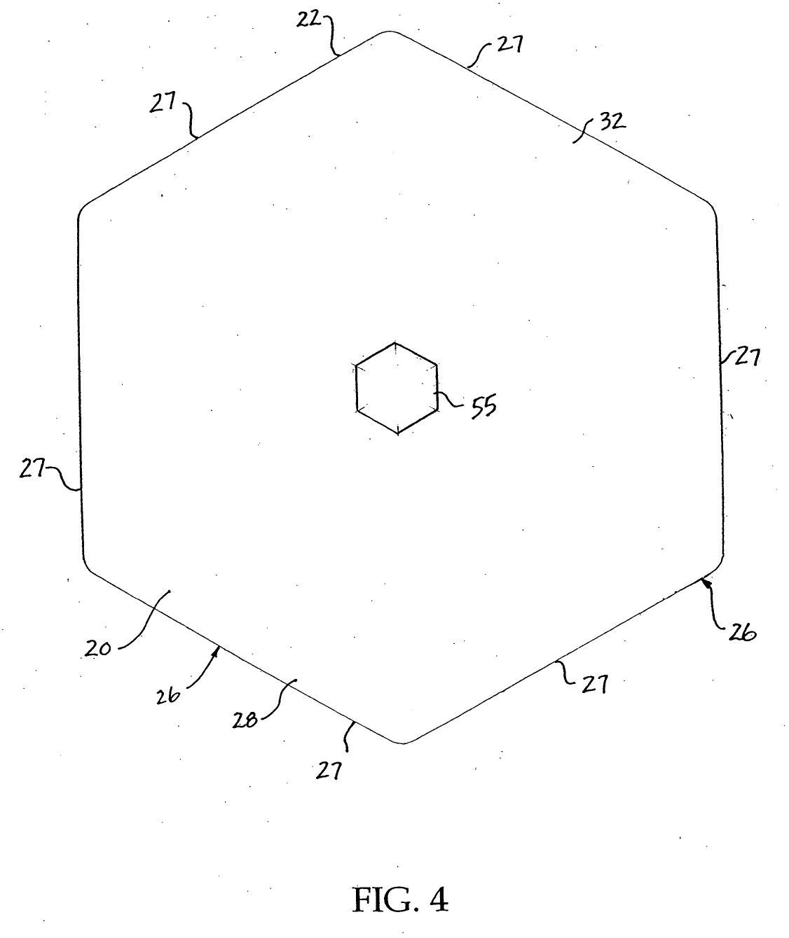

In certain embodiments of this invention, a display piece 55 is mounted or connected to outer surface 32 of cover 20, as shown in FIGS. 4, 12 and 14. Display piece 55 can be weighted at a bottom portion to prevent rotation of display piece 55 with cover 20, and thus to allow display piece 55 to not rotate with respect to axle hub 100 as the vehicle wheel rotates. Display piece 55 may include a suitable or desirable graphic, emblem and/or trademark associated with the owner of the vehicle, for example.

In other embodiments according to this invention, display piece 55 may comprise housing 56, spaced from cap 50, such as shown in FIG. 14. In certain embodiments of this invention, housing 56 may comprise an odometer or another suitable mechanical device that preferably does not rotate with respect to axle hub 100 as the vehicle wheel rotates. Housing 56 can have any suitable shape and/or dimensions. As shown in FIGS. 14 and 15, connector 57, such as a screw, can pass through opening 58, such as a threaded female bore, to secure or otherwise attach housing 56 with respect to plate 12.

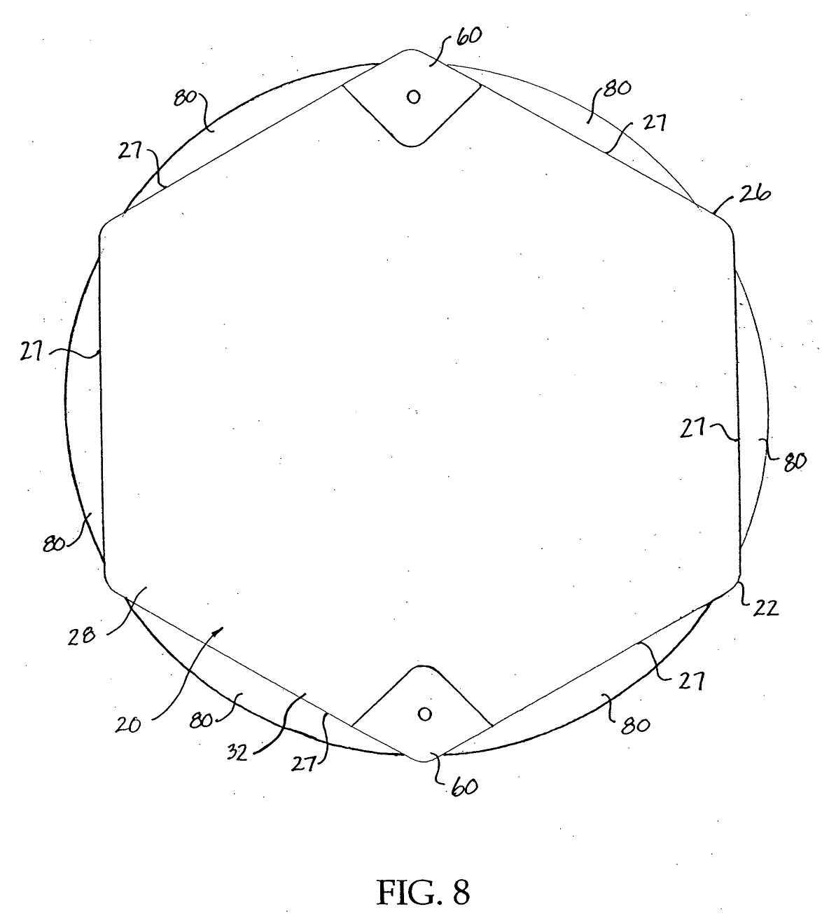

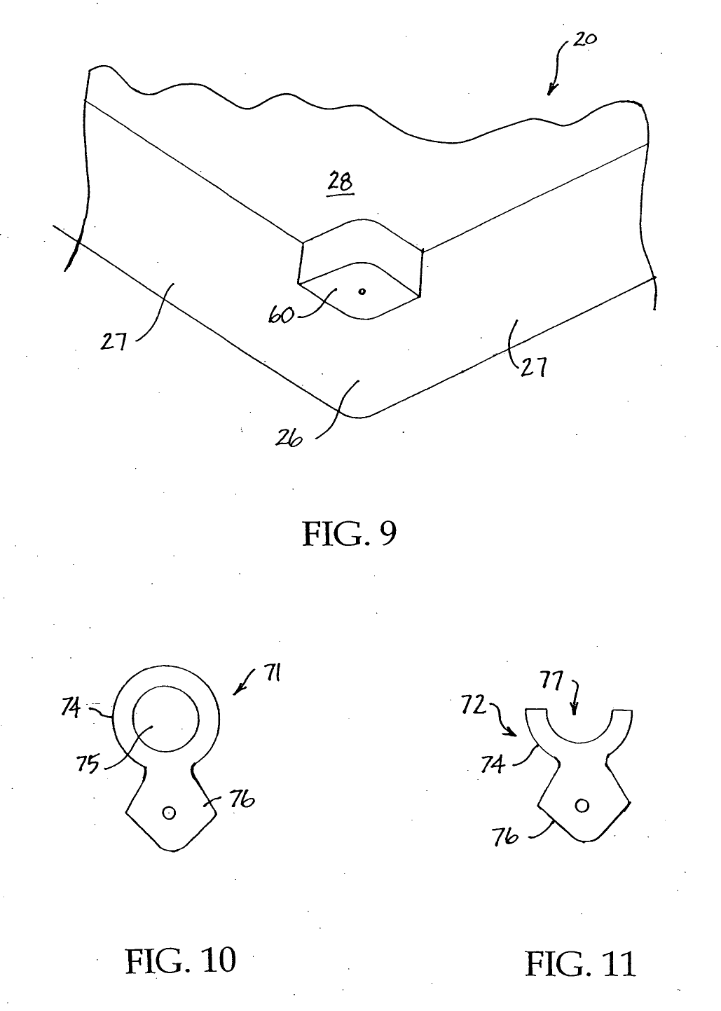

In some embodiments of this invention, at least one and preferably at least two opposing mounting areas 60 are formed in cover 20, as shown in FIG. 8. Referring further to FIG. 9, each mounting area 60 is preferably formed in a portion of sidewall 26. As shown in FIGS. 8 and 9, with adjacent sidewall segments or portions 27 forming sidewall 26, mounting area 60 is preferably formed by adjacent sidewall portions 27 at a transition line or area, such as a bend in sidewall 26.

A mounting element, such as mounting element 71 shown in FIG. 10 or mounting element 72 shown in FIG. 11, is mountable or connectable to cover 20 within mounting area 60. Mounting element 71 includes or forms an opening or hole 75 having a continuous circular shape as shown in FIG. 10, whereas mounting element 72 has an arcuate or semi-circular shape forming an opening 77, as shown in FIG. 11. Preferably, a first portion 74 of mounting element 71 and/or 72 is at least partially positioned within mounting area 60 and connected to cover 20. Mounting element 71 and/or 72 may be fastened to cover 20 at mounting area 60 using a suitable screw or bolt. Alternatively, or in addition, mounting element 71 and/or 72 can be secured within mounting area 60 using a weld or other suitable securement method.

A second portion 76 of mounting element 71 and/or 72 is positionable about at least a portion of a lug bolt 102 fixed on axle hub 100 of the vehicle. With each mounting element 71 and/or 72 positioned about at least a portion of a corresponding lug bolt 102, cover 20 is positioned over axle hub 100 and secured with respect to axle hub 100 using a suitable lug nut 104 threadedly engageable with or attachable to lug bolt 102. In certain embodiments of this invention, cover 20 forms at least one flared flange 80 extending outwardly from sidewall 26 of cover 20, as shown in FIG. 8. Preferably, a flared flange 80 is formed by each sidewall portion 27 to cover a corresponding portion of axle hub 100 extending radially outwardly from outer periphery 22 of cover 20.

As shown in FIGS. 12 and 14, cover or cap 50 is detachably mounted with respect to cover 20. As shown in FIGS. 12 and 14, keeper 51 is fixed with respect to cap 50. One or more keepers 51 can be engaged with an edge portion of cover 20, to fix the position of cap 50 with respect to cover 20. Any other suitable mechanical connection can be used to detachably mount or otherwise detachably attach cap 50 with respect to cover 20.

As shown in FIG. 12, display piece 55 comprises a plate shaped display that can accommodate any suitable graphic or other art piece. As shown in FIG. 12, display piece 55 is connected to, affixed to, integrated with or otherwise attached to shaft 58. Within inner cavity 24, counterweight 59 is fixed, such as with a set screw, with respect to shaft 58. When operating in a gravity environment, counterweight 59 causes display piece 55 to not rotate with respect to axle hub 100 when axle hub 100 rotates as the vehicle wheels move. As shown in FIG. 12, a gap or space is preferably maintained between display piece 55 and cap 50, to eliminate frictional contact. An opposite portion of shaft 58 can be mounted within a bushing or other suitable bearing surface, such as shown in FIG. 12.

FIG. 14 shows housing 56 of display piece 55 mounted with respect to but spaced from cap 50. Housing 56 can be attached with respect to plate 12 using connector 57 or any other suitable mechanical, magnetic and/or adhesive connector. In certain embodiments according to this invention, housing 56 can be an odometer that does not rotate with respect to axle hub 100 when axle hub 100 rotates when a corresponding vehicle has relative movement.

The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. An apparatus mountable with respect to an axle hub of a vehicle, the apparatus comprising:
a plate mountable with respect to the axle hub, the plate forming a plurality of openings, each of the openings positionable about a lug bolt fixed on the axle hub, and the plate forming a plurality of mounting holes; and
a cover forming an inner cavity, and a plurality of connectors positioned within the inner cavity and detachably mounting the cover with respect to the plate.

2. The apparatus of claim 1 wherein each of the connectors is a fastening member passing through a portion of the cover and threadedly engageable within a threaded hole of the plate.

3. The apparatus of claim 1 wherein the plate forms two openings, and each opening is positionable about a lug bolt fixed on the axle hub.

4. The apparatus of claim 3 wherein a lug nut is threadedly engageable with each lug bolt to fasten the plate to the axle hub.

5. The apparatus of claim 4 wherein, with the plate fastened with respect to the axle hub, each mounting hole of a plurality of mounting brackets extends radially beyond a periphery of the axle hub.

6. The apparatus of claim 1 further comprising:
a second plate mountable with respect to the axle hub, and the second plate forming a plurality of second openings each positionable about a lug bolt fixed on the axle hub.

7. An apparatus mountable with respect to an axle hub of a vehicle, the apparatus comprising:
at least one plate mountable with respect to the axle hub, the at least one plate forming a plurality of openings each positionable about a lug bolt fixed on the axle hub with respect to an axle of the vehicle, and the at least one plate forming a plurality of connectors;
a cover forming an inner cavity;
at least a portion of each of the connectors positioned within the inner cavity and detachably connecting the cover to the plate; and
a display piece rotatably mounted with respect to the cover.

8. The apparatus of claim 7 wherein each of the at least one plate is mounted to the axle hub with at least one lug nut threadedly engageable with a corresponding lug bolt.

9. The apparatus of claim 7 wherein the cover has an outer periphery having one of a circular, an elliptical, a triangular, a rectangular and a polygonal shape.

10. The apparatus of claim 7 wherein the display piece comprises a plate that is rotatably mounted with respect to the cover.

11. The apparatus of claim 10 wherein a counterweight is fixed with respect to the display piece.

12. The apparatus of claim 7 wherein the display piece comprises a housing that is rotatably mounted with respect to the cover.

13. The apparatus of claim 11 wherein the housing displays an odometer.

14. The apparatus of claim 7 further comprising a display piece mounted to an outer surface of the cover, and the display piece has a weighted bottom portion to prevent rotation of the display piece with the cover as the axle hub rotates.

15. An apparatus mountable with respect to an axle hub of a vehicle, the apparatus comprising:
a cover forming an inner cavity and having a sidewall;
a first mounting area formed in a portion of the sidewall;
a mounting element having a first portion at least partially positioned within the mounting area and connected to the cover, a second portion of the mounting element positionable about at least a portion of a lug bolt fixed on the axle hub with respect to the axle.

16. The apparatus of claim 15 wherein the cover forms at least one flared flange extending outwardly from the sidewall of the cover.

17. The apparatus of claim 15 wherein the sidewall comprises a plurality of sidewall portions, and each sidewall portion forms a flared flange covering a portion of the axle hub extending radially outwardly from the cover.

18. The apparatus of claim 15 wherein the sidewall comprises a plurality of sidewall portions, and the first mounting area is formed by adjacent sidewall portions.

19. The apparatus of claim 15 wherein the second portion of the mounting element forms one of a circular hole and a semi-circular opening.

20. The apparatus of claim 15 further comprising:
a second mounting area formed in a portion of the sidewall opposing the first mounting area; and
a second mounting element having a first portion at least partially positioned within the second mounting area and connected to the cover, a second portion of the second mounting element positionable about at least a portion of a lug bolt.
